(19) United States
(12) Patent Application Publication
(10) Pub. No.: US 2011/0070794 A1
(43) Pub. Date: Mar. 24, 2011

(54) NONWOVEN SHEET MATERIAL, PANEL CONSTRUCTED THEREFROM AND METHODS OF CONSTRUCTION THEREOF

(76) Inventors: Harry F. Gladfelter, Kimberton, PA (US); Christopher A. Foy, West Chester, PA (US); David Briggs, Newburgh, IN (US); Eric K. Staudt, Reading, PA (US)

(21) Appl. No.: 12/822,453

(22) Filed: Jun. 24, 2010

Related U.S. Application Data
(60) Provisional application No. 61/219,972, filed on Jun. 24, 2009.

(51) Int. Cl. D04H 13/00; B32B 38/10; D04H 1/42; D04H 1/46

(52) U.S. Cl. 442/123; 156/256; 442/417; 442/414; 442/402; 442/378; 442/136; 442/415

(57) ABSTRACT

A nonwoven sheet material and method of construction thereof is provided. The nonwoven sheet material includes a heat bondable textile material and a used post consumer material. The used post consumer material includes at least one of a non-thermoplastic material, thermoplastic material, a plastic composition including different types of plastic constituents, and other materials containing contaminants such as dirt, oil, grease and the like in a non-washed state, which are ordinarily considered non-reusable waste. The used post consumer material is bonded with the heat bondable textile material to form the nonwoven sheet material and panels formed therefrom.

### CROSS-REFERENCE TO RELATED APPLICATIONS

This application claims the benefit of U.S. Provisional Application Ser. No. 61/219,972, filed Jun. 24, 2009, which is incorporated herein by reference in its entirety.

### BACKGROUND OF THE INVENTION

1. Technical Field

This invention relates generally to nonwoven panels and methods for their construction, and more particularly to acoustic, thermal and/or structural panels constructed at least partially from used waste material constituents ordinarily not suitable for reprocessing, more particularly, a mixture including non-thermoplastics and/or different types of plastic/thermoplastic.

2. Related Art

In order to reduce the costs associated with manufacturing nonwoven fabrics and nonwoven materials and to minimize potentially negative affects on the environment, many consumer products are constructed using recycled constituents. For example, automobile manufacturers in the United States use recycled materials to construct nonwoven fabrics and nonwoven materials for various uses, including sound absorbing and/or insulating materials. Some reclaimed or recycled materials used to construct sound absorbing vehicle panels include fabric shoddy, such as, for example, cotton, polyester, nylon, or blends of recycled fabric fibers. Cotton shoddy is made from virgin or recycled fabric scraps that are combined and needled to form a nonwoven fabric. Another product constructed from recycled standard cardboard papers or fibers, used on a limited basis to absorb oils, is Ecco paper. In the process of constructing Ecco paper, the standard cardboard fibers are broken down using dry recycling techniques, and the remaining fibers are combined with various additives.

In addition, it is known to recycle polypropylene (PP) or polyethylene terephthalate (PET) rags. In order to perform their recycle, the rags are typically washed in a centrifuge process. Only after being washed are the rags then melted and reprocessed into a raw pellet form. And, although this process is generally effective in recycling the constituent ingredients of the used rags, it requires the separate cleaning processes prior to forming useful end products from the recycled, used rags, which inevitably adds cost to the process and thus, to the end recycled product.

However, the recycling of various used products, e.g., disposable gloves, aprons, air filters, protective covers, PET tube wipes, foam robot covers, tac rags, Kevlar gloves, Kevlar sleeves, nylon gloves, cotton gloves, paint sludge roll media, sweatshirts, foam bumper covers, glass fiber with thermoplastic thread, etc., including items having more than a single type of plastic material or being constructed of non-thermoplastic materials remains a problem. As such, these types of items are typically not recycled, whether being due to the need for costly cleaning processes and/or lack of an ability to recycle multiple types of plastic in a single process. Accordingly, these types of products remain “waste”, and thus, continue to be sent to landfills or incinerated, and thus, have deleterious affects on the environment.

### SUMMARY OF THE INVENTION

In accordance with one aspect of the invention, a nonwoven product is provided. The nonwoven product includes a heat bondable textile material and a used post consumer material. The used post consumer material includes at least one of a non-thermoplastic material, a thermoplastic material and a material having constituent ingredients including more than one type of plastic material. The used post consumer material is bonded with the heat bondable textile material.

In accordance with another aspect of the invention, the nonwoven product is a vehicle panel.

In accordance with another aspect of the invention, the nonwoven product is a structural member.

In accordance with yet another aspect of the invention, the nonwoven product is constructed to be entirely biodegradable.

According to another aspect of the invention, a method of constructing a nonwoven sheet material from used textile or foam disposables used in manufacturing, other production textile based waste, or other comminutable waste normally unable to be reused that is put into a landfill or incinerated because of cost, melting/bonding, or contamination issues is provided. The nonwoven sheet material constructed is useful for forming at least one of structural, acoustic, thermal panels and vehicle panels. The method includes providing unwashed post consumer scrap. The method includes providing the post consumer scrap including at least one of a non-thermoplastic material, thermoplastic material, a plastic composition including different types of plastic constituents, and other materials containing contaminants such as dirt, oil, grease and the like in a non-washed state. The method further includes comminuting the post consumer scrap into pieces of a predetermined size. Then, forming a mixture by combining the comminuted pieces with heat bondable (low melt) textile fibers, and then, forming a web of the mixture of a predetermined thickness. Further yet, forming a sheet by heating the web to bond the heat bondable material with the comminuted pieces of used waste material.

In accordance with another aspect of the invention, the method includes heating the web in an oven or via a heated roller, rollers, or series of rollers.

In accordance with another aspect of the invention, the method includes needle punching the web prior to being heated.

In accordance with another aspect of the invention, the method includes adding disposable thermoplastic material having low melt fibers to the comminuted pieces of used waste material prior to forming the web.

In accordance with another aspect of the invention, the method includes applying a reflective layer to the web.

In accordance with another aspect of the invention, the method includes treating the used waste material with at least one of an antimicrobial coating and flame retardant coating before and/or after forming the web.

In accordance with another aspect of the invention, the method includes adding a binder and heat bondable (low melt) textile fibers to the comminuted pieces of material prior to forming the web to prevent “dusting out”.

In accordance with another aspect of the invention, the method includes cooling the heated web via a cooling roller or rollers to control the loft, thickness and density of the sheet after heating the web.

In accordance with another aspect of the invention, the method includes cutting the fabricated sheet into any desired shape, depending on the application requirements.

In accordance with another aspect of the invention, the method includes adding filler fibers to the comminuted pieces of material and the low melt material to alter the finished physical properties of the finished, fabricated sheet, as desired.

In accordance with another aspect of the invention, the method includes providing a predetermined quantitative acoustic absorption property to the sheet by controlling the size and the percent by weight of the comminuted pieces of material being mixed with the heat bondable (low melt) textile fibers.

Accordingly, the invention herein overcomes the limitations discussed above by providing nonwoven panels, such as those suitable for use in acoustic, thermal or structural applications and methods for their construction by recycling selected types of non-thermoplastic materials and/or materials having more than a single type of plastic constituent and using them in combination with heat bondable textile materials to create a nonwoven acoustical, thermal or otherwise structural panels that can be used in a variety of applications, such as in automobiles.

### BRIEF DESCRIPTION OF THE DRAWINGS

These and other aspects, features and advantages of the present invention will become more readily appreciated when considered in connection with the following detailed description of presently preferred embodiments and best mode, appended claims and accompanying drawings, in which:

FIG. 1 is a perspective view of a vehicle having nonwoven panels constructed from nonwoven sheet material in accordance with one presently preferred aspect of the invention;

FIGS. 2 and 3 are enlarged cross-sectional views of nonwoven sheet material constructed in accordance with the invention having different sizes and percents by weight of comminuted pieces of used scrap material therein; and

FIG. 4 is a view similar to FIG. 2 shown having an outer layer of reflective material.

### DETAILED DESCRIPTION OF PRESENTLY PREFERRED EMBODIMENTS

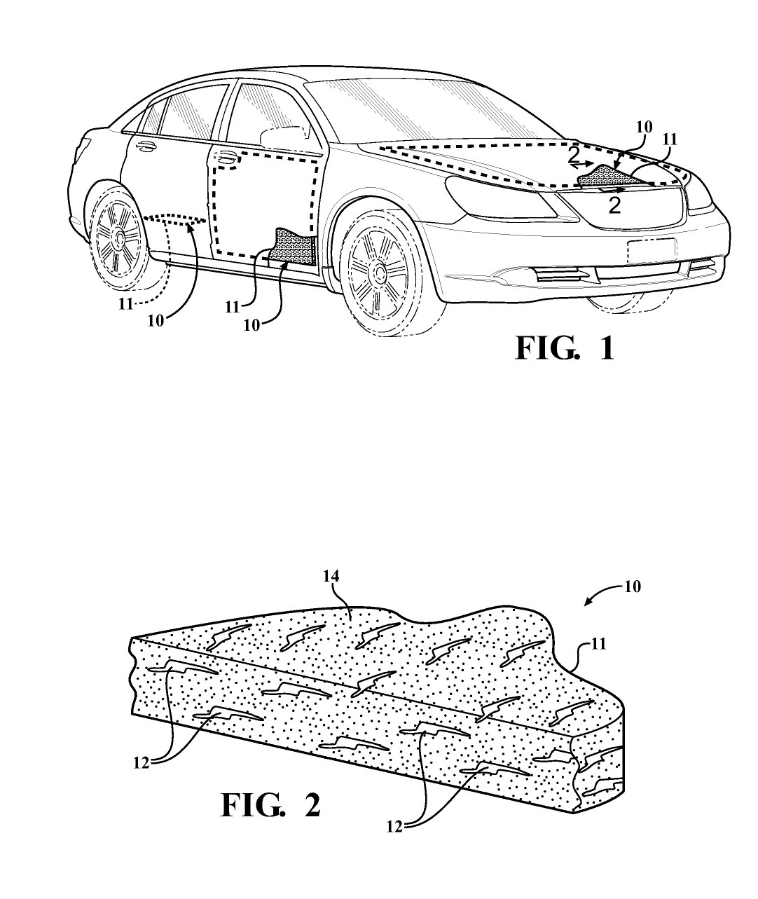

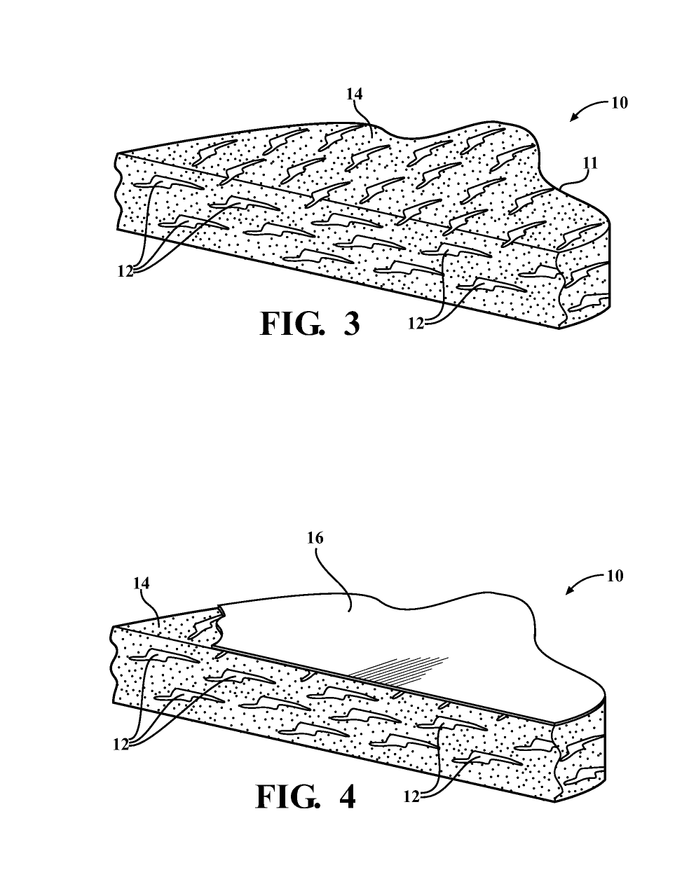

Referring in more detail to the drawings, FIG. 1 illustrates a plurality of panels 10 constructed from a nonwoven sheet material 11 in accordance with one aspect of the invention. The nonwoven sheet material 11 fabricated to form the panels 10, at least in part, is constructed, at least in part, from unwashed post consumer, items. The panels 10 can be configured for use in any number of applications, such as for an automotive vehicle component, as shown in FIG. 1, by way of example and without limitation. The panels 10, aside from being capable of providing a formable structural member, can be fabricated having noise damping or attenuation properties, thus, functioning as an acoustic panel. Further the panels 10 can be constructed having fire retardant properties, if intended for use in high temperature environments, such as near an exhaust system or within a vehicle engine compartment, for example. The panels 10 are constructed from used, reclaimed materials 12, including at least one of non-thermoplastic materials, thermoplastic materials, plastic materials having different types of plastic constituents, other production textile based waste, and other comminutable waste, all of which are normally unable to be reused and that are ordinarily put into a landfill or incinerated because of cost, melting/bonding, or contamination issues. The materials 12 are bonded within the panels 10 with heat bondable textile (low melt) fibers 14, including single or bicomponent fibers. The used waste materials 12 preferably remain in their used, unwashed state, thereby minimizing processing costs. Further, other suitable binder materials and/or filler fibers can be mixed with the used materials 12 to facilitate forming the panel 10, depending on the end use. In addition, various coatings 16 can be applied on at least one outer surface of the panel 10 prior to and/or post bonding of the materials 12. With the panel 10 being constructed, at least in part, from post consumer or otherwise used materials 12, the environment is benefited, such that the reclaimed materials 12 are kept from being sent to landfills or from being incinerated. Further, the manufacturer is benefited by being able to incorporate scrap and items previously considered to be “waste” into useful, saleable product.

The used material 12 can be provided as a mixture including at least one of used, non-thermoplastic materials, thermoplastic material, plastic materials having different types of plastic constituents, other production textile based waste, and other comminutable waste. For example, some used products that, in accordance with the invention, can be fabricated into the sheet material 11 which, till now, were considered non-reusable “waste”, include, without limitation, gloves, such as those constructed from aramid or polyester coated with silicone (more than a single polymer-based material), aprons, air filters and/or protective covers, PET tube wipes, foam robot covers, tac rags, Kevlar gloves, Kevlar sleeves, nylon gloves cotton gloves, paint sludge roll media, sweatshirts, and foam bumpers, by way of example and without limitation. The aforementioned items, or other used items not specifically listed, typically used in manufacturing facilities, such as automotive plants, for example, can, in accordance with the invention, be fabricated into panels 10 while in an unwashed, “as soiled” state. As such, costs associated with cleaning can be avoided.

The heat bondable textile material can be provided, for example, as a low temperature melt polymeric material (low melt), such as fibers of polyethylene, PET or Nylon. Other low melt polymeric materials can also be used, such as thermoplastic bi-component fibers whose outer sheath, such as polypropylene, for example, melts when heated above its melting point. This melted resin then fuses and bonds with the mixture of any textile fibers present and the fibers of the used waste material 12 and with any other binders present. As an example, the melting point of the outer portion of a PET low melt fiber may be between approximately 110° C.-180° C. as compared to the core melting at about 250° C. In addition, the low melt material can be provided as a natural cellulosic fiber or it could also be provided from one or more of the fibers within the waste material 12 used to construct the sheet 11. Persons skilled in the art will recognize that other coatings or fillers and filler fibers may be used in place of low melt fibers to achieve the desired result, and further that the heat bondable material 14 can be used in combination with or replaced by a binder (for example, less low melt fiber can be used if a binder is used to stiffen the feel of the fabric). A SBR with a Tg of +41 is one example of a binder that can be used. Further, the heat bondable textile materials 14 can be combined with other inorganic or organic fibers, such as jute or kenaf, for example, and/or coated with heat resistant or fire retardant (FR) coatings (Ammonium Sulfate, Ammonium Phosphate, or Boric Acid, for example) and/or coated with an anti-microbial coating (Polyphase 678, Rocima 200, or UF-15, for example) on at least one or both of the heat bondable textile materials and the used material 12.

One method of constructing the panels 10 includes providing the waste materials 12, as discussed above, such as by reclaiming used, dirty items, such as those listed above, and then, comminuting the materials 12 without being washed into the desired size pieces and/or dry fibrous state, such as in a chopping, shredding, and/or grinding operation. Depending on the characteristics sought, such as acoustic damping or structural characteristics, for example, the size and percent by weight content of the comminuted pieces or nits can be selectively varied from application to application. It has been found that by altering the size and percent content of the pieces, the acoustic absorption properties of the panels 10 changes. If using a hammer mill to comminute the used items, the screen may be oriented in various directions or take on various shapes, including circular, vertical, or horizontal. If the ground/hammer-milled mixture will be combined with textile fibers, it is then fluffed to facilitate being mixed with the textile fibers.

Another aspect of the invention includes changing the percentage of the material 12 used in the panel 10 to customize the sound absorption curve of the final panel. Depending on what “filler” fiber is used, the material 12 may increase the sound absorption values or it may actually decrease the sound absorption values of the final panel. By changing the weight percentage of material 12 used in the panel 10 along with the size of the pieces and/or size of the fibers of the material 12, the panel 10 can be engineered to have any absorption curve required by the application.

The hammer-milled fibers and fragments of the material 12 are then blended with any desired recycled or virgin textile fibers, which may include the low-melt fibers 14, other binder materials or coatings, as mentioned. The proportion of the hammer-milled fibers, if incorporated, and fragments of waste material 12 to textile fibers 14 can be varied as best suited for the intended application of the panel 10. The low melt fibers 14 can be provided in such a low percentage, such as about 5%, for example, that their content in the finished panel 10 will be substantially indiscernible.

The mixture is then subjected to a nonwoven webbing process, which may be performed, for example, on a Rando machine, or other more current air lay systems. The webbing process forms a homogenous or substantially homogenous mixed fiber mat or web, with the fibers of the material 12 being randomly oriented. The web is then run through a heat bonding oven to melt the low melt fibers. Otherwise, according to an alternative aspect of the invention, prior to heating the web, the web can be first fed through a needle loom to be needle punched. Regardless, the heating process may be performed by passing the web into or through any suitable oven, or by feeding it through one or more heated rollers. The resulting web may then be passed between cooling rollers after heating to control its thickness and density. If needle punching the web, a thin nonwoven layer that resists tearing, or a scrim layer, may be applied to one or both sides of the web to prevent any of the material fibers or pieces 12 from building up on the needles, as build-up of material 12 on the needles is undesirable and may cause them to break. The scrim layer also serves as a “net” to control dust from being released from the web. Reemay fabric is one example of a scrim that can be used for this purpose. The scrim or protective layer of fabric may additionally add strength to the web and facilitate the webbing process. The web can also be coated with a binder prior and/or after heating the web, which further binds all of the fibers and material in place and prevents it from forming dust (SBR, Acrylic, or Latex binders are some examples of what can be used). Flame retardant additives can also be added to the coating. Upon applying the binder, it is preferably dried and cured.

The web can then be rolled up or cut into desired lengths. A cutting press, or a comparable apparatus, can be used to separate the roll/sheets into panels or parts as dictated by the application of the fiber product.

The resulting nonwoven panels 10 may have a thin nonwoven fabric, scrim and/or reflective layer 16 attached or bonded to one side or both sides, or sandwiched between layers of the nonwoven fiber panels 10. The scrim and/or reflective layer can be bonded using a suitable heat resistant adhesive, a low-melt blend of fibers within the scrim, or it can be attached via stitch-bonding. The reflective layers 16, e.g. foil, enhance the thermal heat resistant properties of the panel 10. The panel 10 and scrim or reflective layers 16 can be structured in a lamination, thereby providing multiple layers, as desired, of panels 10 and intervening scrim and/or reflective layers 16.

The nonwoven panels 10 constructed in accordance with the invention are suitable for use in a variety of applications, including acoustic panels and thermal panels in automobiles. Such applications more specifically include the acoustic panels between the finished interior panel and the steel of the car, including, the headliner, side door panels, the trunk, and under the carpet. Thermal applications include, for example, heat shields with the addition of a reflective layer, such as adjacent exhaust system components or within an engine compartment. Other applications may include thermally compressed parts or composites.

Many modifications and variations of the present invention are possible in light of the above teachings. It is, therefore, to be understood that the invention may be practiced otherwise than as specifically described, and that the scope of the invention is defined by any ultimately allowed claims.

What is claimed is:

1. A method of constructing a nonwoven sheet material from at least one of used textile materials, foam disposables used in manufacturing, other production textile based waste, or other comminutable waste, all of which are normally unable to be reused and that are ordinarily put into a landfill or incinerated because of cost, melting/bonding, or contamination issues, the sheet material being useful for forming at least one of structural, acoustic panels, thermal panels, and vehicle panels, the method comprising:
providing at least one of the used, unwashed non-thermoplastic material, unwashed thermoplastic material, and unwashed material having more than one type of plastic constituent;
comminuting the unwashed material into reduced sized pieces;
combining the reduced sized pieces with a heat bondable textile material to form a mixture;
forming a web of the mixture of a predetermined thickness in a dry nonwoven webbing process; and
heating the web to bond the heat bondable material with the reduced sized pieces to form the nonwoven sheet.

2. The method of claim 1 further including providing a predetermined quantitative acoustic absorption property to the finished sheet by controlling the size and percent by weight of the reduced size pieces being mixed in the web.

3. The method of claim 1 further including heating the web in an oven or via a heated roller, rollers, or series of rollers.

4. The method of claim 1 further including needle punching the web prior to being heated.

5. The method of claim 1 further including adding disposable thermoplastic material having low melt fibers to the comminuted pieces of material prior to forming the web.

6. The method of claim 1 further including applying an outer reflective layer to the web.

7. The method of claim 6 further including providing the outer reflective layer as foil.

8. The method of claim 1 further including treating the used material with at least one of an antimicrobial coating and flame retardant coating before forming the web.

9. The method of claim 1 further including treating the used material with at least one of an antimicrobial coating and flame retardant coating after forming the web.

10. The method of claim 1 further including adding a binder and heat bondable textile fibers to the comminuted pieces of material prior to forming the web.

11. The method of claim 1 further including controlling the loft, thickness and density of the sheet after heating the web by cooling the heated web via at least one cooling roller.

12. The method of claim 1 further including altering the finished physical properties of the finished sheet by adding filler fibers to the comminuted pieces of material and the heat bondable textile material prior to forming the web.

13. A nonwoven sheet material, comprising:
a heat bondable textile material; and
a used, unwashed post consumer comminuted material including at least one of non-thermoplastic material, thermoplastic material and constituent ingredients including more than one type of plastic material, said used, unwashed post consumer material being bonded with said heat bondable textile material.

14. The nonwoven sheet material of claim 13 wherein said sheet material is formed into a vehicle panel.

15. The nonwoven sheet material of claim 13 wherein said sheet material is formed into a structural member.

16. The nonwoven sheet material of claim 13 wherein said sheet material is entirely biodegradable.

17. The nonwoven sheet material of claim 13 wherein a predetermined quantitative acoustic absorption property is provided in the finished sheet material by controlling the size and percent by weight of the used, unwashed post consumer material.

18. The nonwoven sheet material of claim 1 wherein said sheet material is needle punched.

19. The nonwoven sheet material of claim 13 further including an outer reflective layer.

20. The nonwoven sheet material of claim 19 wherein said outer reflective layer is foil.

21. The nonwoven sheet material of claim 13 further including at least one of an antimicrobial coating and flame retardant coating contained in said sheet material.

22. The nonwoven sheet material of claim 13 further comprising filler fibers bonded with the comminuted pieces of material.
